(19) United States
(12) Patent Application Publication
(10) Pub. No.: US 2008/0172535 A1
(43) Pub. Date: Jul. 17, 2008

(54) BUFFERING MODULE SET IN OPTICAL DISC DRIVE AND RELATED METHOD OF BUFFERING DATA

(76) Inventors: Ching-Wen Hsueh, I-Lan Hsien (TW); Li-Lien Lin, Hsinchu City (TW); Jia-Horng SHIEH, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/964,040

(22) Filed: Dec. 25, 2007

(30) Foreign Application Priority Data
Jan. 11, 2007 (TW) 096101087

(51) Int. Cl. G06F 12/16

(52) U.S. Cl. 711/161; 711/E12.103

(57) ABSTRACT

A method for buffering data when reading an optical disc is disclosed in the present invention. The method includes providing a memory page with a plurality of memory spaces corresponding to a memory space matrix with M rows×N columns, reading data stored in the optical disc to generate a block to be decoded, selecting M rows×N columns of data from the block to be decoded as a sub-block to be decoded, and storing the M rows of data of the sub-block to be decoded into the M rows of memory spaces of the memory space matrix respectively.

### BACKGROUND

The present disclosure is related to optical storage, and more particularly, to a method and related buffering module for buffering data when accessing an optical disc.

Recently optical storage has become a data storage media with widespread applications, for example, digital versatile disc (DVD), high definition DVD (HDDVD), and blue-ray disc (BD) are several kinds of the optical storage that can supply huge memory space.

When an optical disc drive accesses (read or write) an optical disc (such as a DVD, a HDDVD, or a BD), a volatile memory is necessary to be used for supplying a space for buffering data. Generally speaking, the volatile memory usually can be a dynamic random access memory (DRAM). In the following, memory usage for reading data is taken as an example for illustration.

Please refer to FIG. 1. FIG. 1 is a diagram showing an error correction code block (ECC block) 100 generated from reading a DVD disc or a HDDVD disc by an optical disc drive. The error correction code block 100 of the DVD disc (or HDDVD disc) totally includes 208 rows×182 columns of data (a size of each data equals one byte), whereof 16 rows are parity outer codes (PO) and 10 columns are parity inner codes (PI). The configuration manner in the prior art is to make accesses in a 1^{st} direction correspond to continuous memory addresses, thus the accesses in the 1^{st} direction can have preferred efficiency. First of all, each data is generated sequentially along the horizontal direction (that is the 1^{st} direction in FIG. 1) when reading data, these data will be stored into a DRAM sequentially along the 1^{st} direction. Each page of the DRAM usually includes a memory space of 512 bytes, for example, the optical disc drive will store the 512 bytes B_{0,0}, B_{0,1}, B_{0,2}, . . . , B_{0,181}, B_{1,0}, B_{1,1}, B_{1,2}, . . . , B_{1,181}, B_{2,0}, B_{2,1}, B_{2,2}, . . . , and B_{2,147}, into a j^{th} memory page of the DRAM. Similarly, the following 512 bytes B_{2,148}, B_{2,149}, . . . , B_{5,112}, and B_{5,113} will be stored into a (j+1)^{th} memory page of the DRAM. The 512 bytes B_{5,114}, B_{5,115}, . . . , B_{6,78}, and B_{6,79} will be stored into a (j+2)^{th} memory page of the DRAM, and so on. In other words, the data read out from the DVD disc is sequentially stored into the continuous memory addresses of the DRAM. Similarly, each data is read out sequentially from the DRAM along the 1^{st} direction and is transmitted to a host device after decoding. At this time, the memory addresses are still continuous. Thus under the best condition, 512 bytes can be accessed at one time without a page miss.

As decoding the parity outer codes, data must be accessed along the vertical direction (the 2^{nd} direction in FIG. 2). Thus data of each column is read out from the DRAM along the 2^{nd} direction for decoding (correcting the data for any errors) and the decoded data of each column is written into the DRAM along the 2^{nd} direction. Due to the addresses of any two adjacent bytes of each column being apart from each other for at least 182 bytes of memory address, a page miss will happen every time when accessing two or three bytes.

Under the abovementioned configuration manner, the access efficiency of the 1^{st} direction is good. Under the best condition, 512 bytes can be accessed at one time without a page miss. Therefore, FIFO buffers for the accesses of the 1^{st} direction must increase. On the other hand, due to a page miss happening every time when accessing two or three bytes along the 2^{nd} direction, the latency when the DRAM accesses along the 2^{nd} direction is lengthened. Hence, FIFO buffers for the accesses of the 2^{nd} direction must increase, too. However, a FIFO buffer of 64 bytes is considerably large in a common system, so the abovementioned configuration manner cannot provide the best whole access efficiency.

The condition when reading a BD disc is introduced as follows. FIG. 2 is a diagram showing an error correction code block 200 generated from reading a BD disc. The error correction code block 200 of the BD disc totally includes 496 rows×156 columns of data (a size of each data equals one byte), whereof 64 rows are parity data. The configuration manner in the prior art is to make accesses in the 2^{nd} direction correspond to continuous memory addresses, thus the accesses in the 2^{nd} direction can have preferred efficiency. First of all, each data is generated sequentially along the horizontal direction (that is the 1^{st} direction in FIG. 2) when reading data of the BD disc, these data will be stored into the DRAM sequentially along the 1^{st} direction (the stored memory addresses are not continuous). As described above, each page of the DRAM usually includes a memory space of 512 bytes. For example, the optical disc drive will store the 512 bytes B_{0,0}, B_{1,0}, B_{2,0}, . . . , B_{495,0}, B_{0,1}, B_{1,1}, B_{2,1}, . . . , and B_{15,1} into a k^{th} memory page of the DRAM. Similarly, the following 512 bytes B_{16,1}, B_{17,1}, . . . , B_{30,2}, and B_{31,2} will be stored into a (k+1)^{th} memory page of the DRAM. The 512 bytes B_{32,2}, B_{33,2}, . . . , B_{46,3}, and B_{47,3} will be stored into a (k+2)^{th} memory page of the DRAM, and so on. In other words, when storing the data read out from the BD disc into the DRAM, a page miss will happen every time when accessing one or two bytes due to the memory addresses are not continuous.

Data must be accessed along the vertical direction (the 2^{nd} direction) when decoding the parity data. Thus data of each column is read out from the DRAM along the 2^{nd} direction for decoding (correcting the data for any errors) and the decoded data of each column is written into the DRAM along the 2^{nd} direction. At this time, the memory addresses are continuous. Under the best condition, 512 bytes can be accessed at one time without a page miss. Similarly, the data of each column is read out sequentially from the DRAM along the 2^{nd} direction and is transmitted to a host device after decoding. At this time, the memory addresses are still continuous so that 512 bytes can be accessed at one time without page miss under the best condition.

Under the abovementioned configuration manner, the access efficiency of the 2^{nd} direction is good. Under the best condition, 512 bytes can be accessed at one time without a page miss. Therefore, FIFO buffers for the accesses of the 2^{nd} direction must increase. On the other hand, due to a page miss happening every time when accessing one or two bytes along the 1^{st} direction, the latency when the DRAM accesses along the 1^{st} direction is lengthened. Hence, FIFO buffers for the accesses of the 1^{st} direction must increase, too. However, a FIFO buffer of 64 bytes is considerably large in a common system, so the abovementioned configuration manner cannot provide the best whole access efficiency.

### SUMMARY OF THE DISCLOSURE

It is an objective of the claimed disclosure to provide a method and related buffering module for utilizing one or many memory pages of a memory to look after access efficiency in both two directions simultaneously through matrix mapping when accessing an optical disc.

According to an embodiment of the present disclosure, a method for buffering data when reading an optical disc is disclosed. The method includes providing a memory page with a plurality of memory spaces corresponding to a memory space matrix with M rows×N columns; and reading data stored in the optical disc to generate a block to be decoded, selecting M rows×N columns of data from the block to be decoded as a sub-block to be decoded, and storing the M rows of data of the sub-block to be decoded into the M rows of memory spaces of the memory space matrix respectively.

According to an embodiment of the present disclosure, a buffering module for an optical disc drive is disclosed. The optical disc drive includes a reading module, a decoding module, and a host interface. The buffering module includes a memory that includes a memory page with a plurality of memory spaces corresponding to a memory space matrix with M rows×N columns. The buffering module further includes a memory controller coupled to the memory, the reading module, the decoding module, and the host interface. The memory controller is used for receiving a block to be decoded obtained through reading an optical disc by the reading module, selecting M rows×N columns of data from the block to be decoded as a sub-block to be decoded, and storing the M rows of data of the sub-block to be decoded into the M rows of memory spaces of the memory space matrix respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an ECC block generated from reading a DVD disc or a HDDVD disc.

FIG. 2 is a diagram showing an ECC block generated from reading a BD disc.

FIG. 3 is a diagram of an optical disc drive according to an embodiment of the present disclosure.

FIG. 4 is a configuration diagram of memory spaces of a memory page when the optical disc drive in FIG. 3 is accessing a DVD disc or a HDDVD disc.

FIG. 5 is a flow diagram illustrating a method for the optical disc drive in FIG. 3 to read a DVD disc or a HDDVD disc.

FIG. 6 is a configuration diagram of memory spaces of a memory page when the optical disc drive in FIG. 3 is accessing a BD disc.

FIG. 7 is a flow diagram illustrating a method for the optical disc drive in FIG. 3 to read a BD disc.

FIG. 8 is a flow diagram illustrating a method for the optical disc drive in FIG. 3 to write data into a DVD disc or a HDDVD disc.

FIG. 9 is a flow diagram illustrating a method for the optical disc drive in FIG. 3 to write data into a BD disc.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

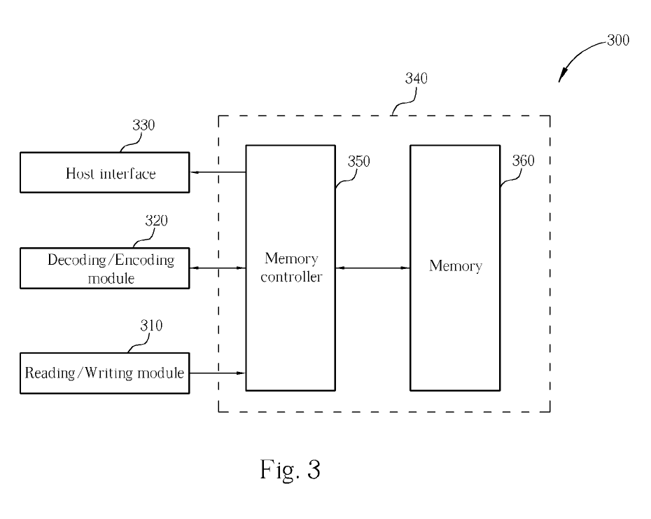

Please refer to FIG. 3. FIG. 3 is a diagram of an optical disc drive 300 according to an embodiment of the present disclosure. In this embodiment, the optical disc drive 300 includes a reading/writing module 310, a decoding/encoding module 320, a host interface 330, and a buffering module 340, wherein the buffering module 340 includes a memory controller 350 and a memory 360. For example, the memory can be a DRAM and the memory controller 350 can be a DRAM controller. Please note that, the function blocks 310 and 320 are respectively called the reading module and the decoding module when the optical disc drive 300 is reading data from the optical disc, the function blocks 310 and 320 are respectively called the writing module and the encoding module when the optical disc drive 300 is writing data into the optical disc, and the function blocks 310 and 320 are respectively called the reading-writing module and the decoding-encoding module when the function block 310 possesses both read and write functions and the function block 320 possesses both decode and encode functions. Furthermore, the reading and writing operation of the optical disc drive is called access.

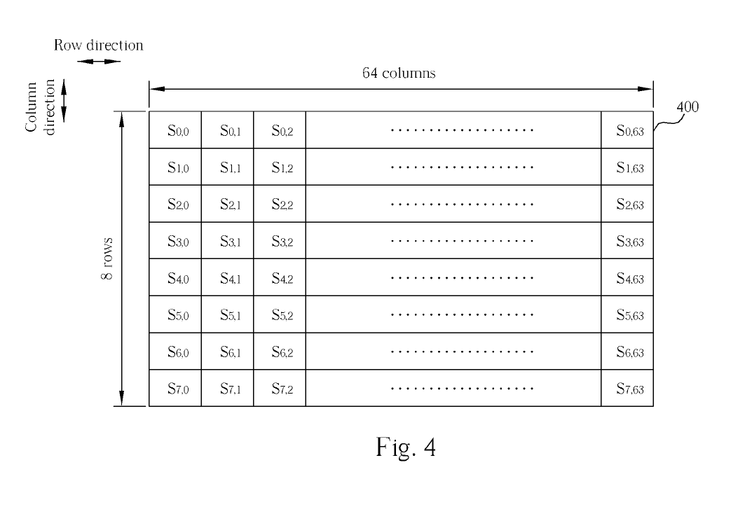

The memory 360 includes a plurality of memory pages, whereof a plurality of memory spaces of each memory page correspond to a matrix (for example, the plurality of memory spaces correspond to a matrix with M rows×N columns). In other words, each memory page can be thought of as a memory space matrix composed of M rows×N columns memory spaces (each memory space can store a byte of data). As for the DVD disc and the HDDVD disc, the numbers M and N can individually be set as 8 and 64. Thus the memory space matrix corresponding to each memory page is shown in FIG. 4, whereof the memory spaces S_{0,0}, S_{0,1}, S_{0,2}, . . . , S_{0,63}, S_{1,0}, S_{1,1}, . . . , S_{6,63}, S_{7,0}, S_{7,1}, . . . , S_{7,63} sequentially correspond to continuous memory addresses. That is, every two adjacent memory spaces in each row of memory spaces correspond to two continuous memory addresses (for example, the memory spaces S_{0,0} and S_{0,1} correspond to two continuous memory addresses); and every two adjacent memory spaces in each column of memory spaces correspond to two memory addresses with a fixed address difference (for example, the address difference between the memory spaces S_{0,0} and S_{1,0} is 64 bytes, and the address difference between the memory spaces S_{1,0} and S_{2,0} is 64 bytes, too).

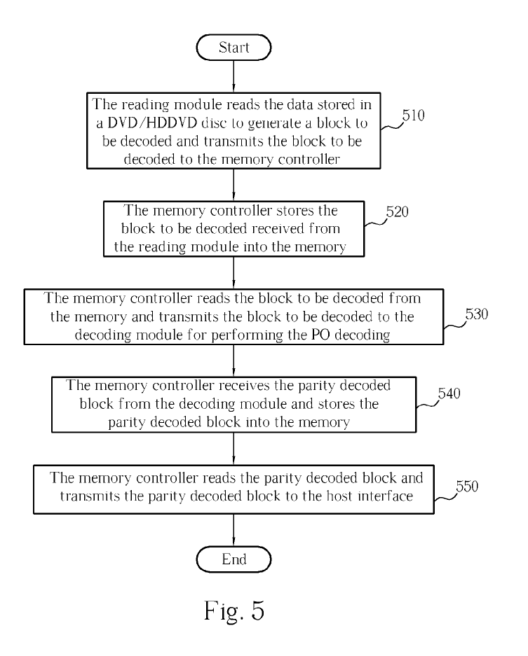

Please refer to FIG. 5. FIG. 5 is a flow diagram illustrating a method for the optical disc drive 300 in FIG. 3 to read a DVD disc or a HDDVD disc. The flow diagram includes the following steps:

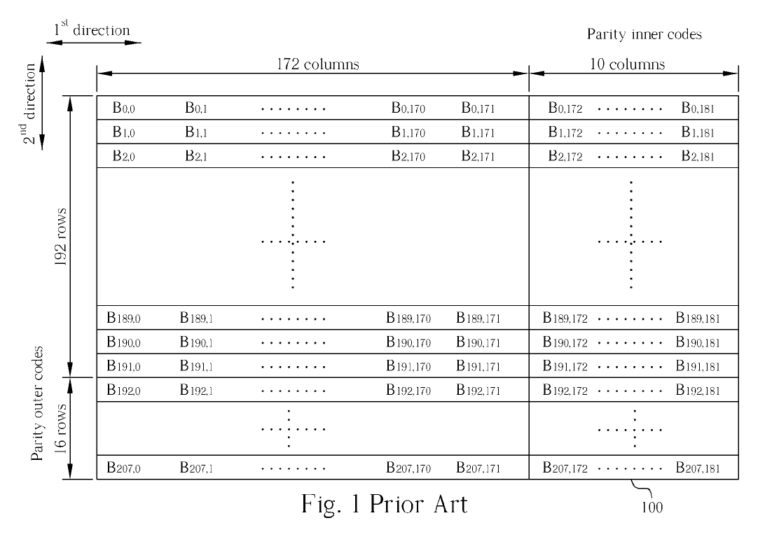

Step 510: The reading module 310 reads data stored in the DVD disc to obtain an error correction code block 100 of FIG. 1 and performs a PI decoding on the error correction code block 100 to obtain a PI decoded block, and treats the PI decoded block as a block to be decoded and transmits the PI decoded block to the memory controller 350. Please note that, in this step, the reading module 310 can deliver the job of “performing the PI decoding on the error correction code block 100” to the decoding module 320.

Step 520: The memory controller 350 stores the block to be decoded (the PI decoding has already been performed) received from the reading module 310 into the memory 360. Please refer to FIG. 1, in order to consider both the access efficiencies in the 1^{st} direction and in the 2^{nd} direction, the memory controller 350 will divide the block to be decoded into a plurality of sub-blocks with matrix characteristics, and store the data of each row of each sub-block into the memory spaces of each row of each memory page in the memory 360. Please note that, each of the blocks to be decoded is called as a block to be processed, and each sub-block is called as a sub-block to be decoded or a sub-block to be processed.

Utilizing cooperation with the error correction code block 100 in FIG. 1 and taking the memory space configuration in FIG. 4 as example, the memory controller 350 can select a rectangular data block having the bytes B_{0,0}, B_{0,63}, B_{7,0}, and B_{7,63} located at four corners as a first sub-block and individually store the eight rows data of the first sub-block into eight rows of memory spaces of a j^{th} memory page; select a rectangular data block having the bytes B_{0,64}, B_{0,127}, B_{7,64}, and B_{7,127} located at four corners as a second sub-block and individually store the eight rows data of the second sub-block into eight rows of memory spaces of a (j+1)^{th} memory page; select a rectangular data block having the bytes B_{0,128}, B_{0,171}, B_{7,128}, and B_{7,171} located at four corners as a third sub-block (because the parity inner codes PI have been decoded already) and individually store the eight rows data of the third sub-block into eight rows of memory spaces of a (j+2)^{th} memory page, and so on.

Please note that, the access operation is corresponding to the 1^{st} direction in FIG. 1. As for accessing the data of each row (each row includes 172 bytes), 64 bytes can be accessed at one time without a page miss in the step. In other words, a page miss will happen every time after accessing 64 bytes. Moreover, due to 172 being not divisible by 64 with no remainder, the 45^{th}, 46^{th}, . . . , 64^{th} columns of memory spaces of the (j+2)^{th}, (j+5)^{th}, (j+8)^{th}, . . . , (j+77)^{th} memory pages are not occupied by the data of the block to be decoded. Thus, the memory controller 350 can utilize the non-occupied memory spaces to store other data.

Step 530: The memory controller 350 reads the PI decoded block from the memory 360 and transmits the PI decoded block to the decoding module 320 for performing the PO decoding. At this time, the access operation is along the 2^{nd} direction in FIG. 1, which is the column direction of the memory space matrix that each memory page corresponds to in FIG. 4. The data of each column is read out and transmitted to the decoding module 320 for performing decoding. To explain more explicitly, the memory controller 350 can individually read the data from the 1^{st} column, the 2^{nd} column, . . . , and the 64^{th} column of the j^{th}, (j+3)^{th}, (j+6)^{th}, . . . , and (j+75)^{th} memory pages in the memory 360 and transmit each column to the decoding module 320 for performing the PO decoding. Due to each column including eight pieces of data, 8 bytes can be accessed at one time without a page miss in the step. In other words, a page miss will happen every time after accessing 8 bytes.

Step 540: The memory controller 350 receives the parity decoded block from the decoding module 320 (that includes both the PI decoded block and the PO decoded block) and stores the parity decoded block into the memory 360. The access operation is along the 2^{nd} direction in FIG. 1, wherein the data stored into the memory 360 only includes 192 rows×172 columns (these data have already been PI decoded and PO decoded and may be a little different from the data inside the rectangular data block having the bytes B_{0,0}, B_{0,171}, B_{191,0}, and B_{191,171} located at four corners in FIG. 1). At this time, the memory controller 350 will divide the received parity decoded block into several sub-blocks and store each column of data of each sub-block into each column of memory spaces of each memory page in the memory 360.

For example, the memory controller 350 can select a rectangular data block having the bytes B_{0,0}, B_{0,63}, B_{7,0}, and B_{7,63} located at four corners as a first sub-block and individually store the 64 columns data of the first sub-block into 64 columns memory spaces of a k^{th} memory page (the value of k in this step can equal the value of j in step 520); select a rectangular data block having the bytes B_{0,64}, B_{0,127}, B_{7,64}, and B_{7,127} located at four corners as a second sub-block and individually store the 64 columns data of the second sub-block into 64 columns of memory spaces of a (k+1)^{th} memory page; select a rectangular data block having the bytes B_{0,128}, B_{0,171}, B_{7,128}, and B_{7,171} located at four corners as a third sub-block and individually store the 64 columns data of the third sub-block into 64 columns of memory spaces of a (k+2)^{th} memory page, and so on.

Please note that, the access operation is corresponding to the 2^{nd} direction in FIG. 1. As for accessing the data of each column (each column includes 8 bytes), 8 bytes can be accessed at one time without a page miss in the step. In other words, a page miss will happen every time after accessing 8 bytes Moreover, due to 172 being not divisible by 64 with no remainder, the 45^{th}, 46^{th}, . . . , 64^{th} columns of memory spaces of the (k+2)^{th}, (k+5)^{th}, (k+8)^{th} . . . , (k+71)^{th} memory pages are not occupied by the parity decoded block. Thus, the memory controller 350 can utilize the non-occupied memory spaces to store other data.

Step 550: The memory controller 350 read the parity decoded block from the memory 360 and transmits the parity decoded block to the host interface 330 (the host interface 330 can transmit the received data to a host device). At this time, the access operation is along the 1^{st} direction in FIG. 1, which is the row direction of the memory space matrix that each memory page corresponds to in FIG. 4. The data of each row is read out and transmitted to the host interface 330. To explain more explicitly, the memory controller 350 can individually read the data from the 1^{st} row, the 2^{nd} row, . . . , and the 8^{th} row of the k^{th}, (k+1)^{th}, and (k+2)^{th} memory pages and transmit them to the host interface 330. Due to each row including 64 data, 64 bytes can be accessed at one time without a page miss in the step. In other words, a page miss will happen every time after accessing 64 bytes.

The memory spaces of each memory page of the memory 360 are utilized through the abovementioned matrix corresponding manner. When accessing the DVD disc (or the HDDVD disc), both the access efficiencies of the 1^{st} direction and the 2^{nd} direction in FIG. 1 can be considered. When accessing along the 1^{st} direction, 64 bytes can be accessed at one time without a page miss due to the memory addresses being continuous. When accessing along the 2^{nd} direction, 8 bytes can be accessed at one time without a page miss due to the memory addresses being increased by 64 bytes every time. Hence, the access efficiency along the 2^{nd} direction is 2.6-4 times that of the prior art. Under this configuration, FIFO buffers for the accesses of the 1^{st} direction only require 64 bytes and FIFO buffers for the accesses of the 2^{nd} direction only need 8 bytes, which can elaborate this kind of matrix corresponding manner to a maximum efficiency.

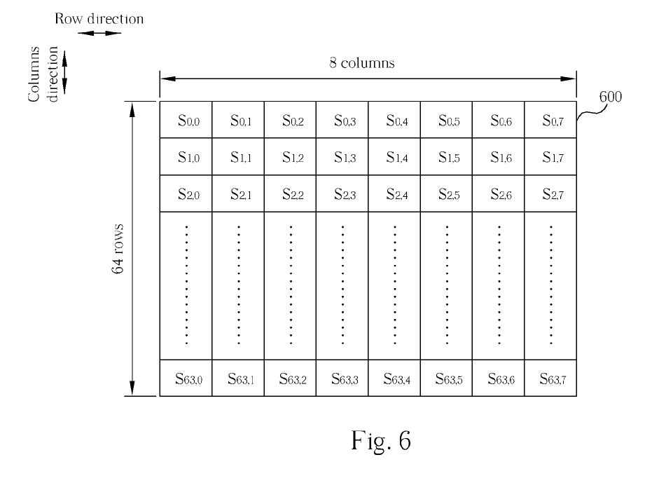

As for the BD disc, which is a little different from the DVD disc and the HDDVD disc. The numbers M and N can be individually set as 64 and 8 for the BD disc, that is, each memory page of the memory 360 can be thought of as a memory space matrix composed of 64 rows×8 columns memory spaces (each memory space can store a byte of data). At this time, the memory space matrix that each memory page corresponds to is shown in FIG. 6, whereof the memory spaces S_{0,0}, S_{1,0}, S_{2,0}, . . . , S_{63,0}, S_{0,1}, S_{1,1}, . . . , S_{63,6}, S_{0,7}, S_{1,7}, . . . , S_{63,7} sequentially correspond to continuous memory addresses. That is, every two adjacent memory spaces in each column of memory spaces correspond to two continuous memory addresses (for example, the memory spaces S_{0,0} and S_{1,0} correspond to two continuous memory addresses); and every two adjacent memory spaces in each row of memory spaces correspond to two memory addresses with a fixed address difference (for example, the address difference between the memory spaces S_{0,0} and S_{0,1} is 64 bytes, and the address difference between the memory spaces S_{0,1} and S_{0,2} is 64 bytes, too).

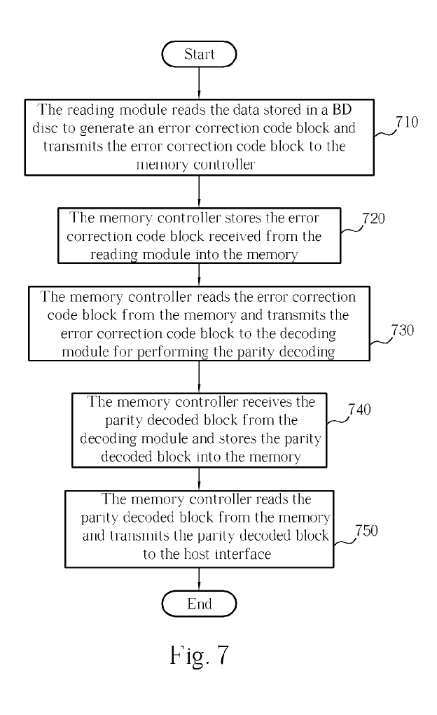

Please refer to FIG. 7. FIG. 7 is a flow diagram illustrating a method for the optical disc drive 300 in FIG. 3 to read a BD disc. The flow diagram includes the following steps:

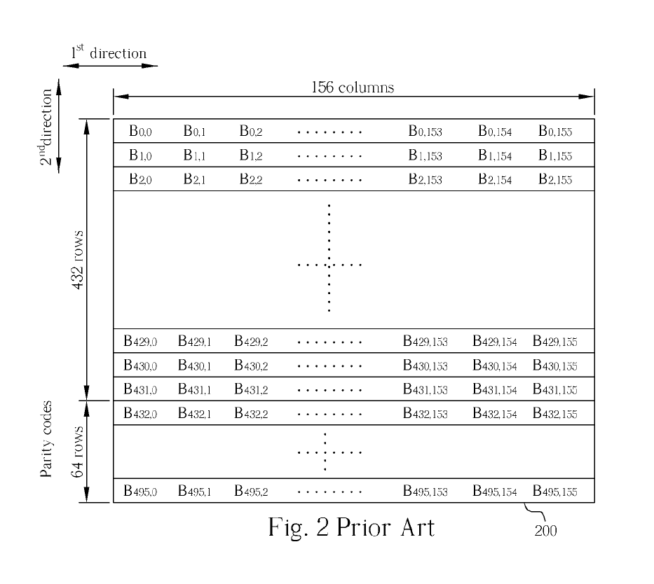

Step 710: The reading module 310 reads data stored in the BD disc to obtain an error correction code block 200 of FIG. 2 and transmits the error correction code block 200 to the memory controller 350.

Step 720: The memory controller 350 stores the error correction code block 200 received from the reading module 310 into the memory 360. Please refer back to FIG. 2, in order to consider both the access efficiencies in the 1^{st} direction and in the 2^{nd} direction, the memory controller 350 will divide the error correction code block 200 into a plurality of sub-blocks and store each row data of each sub-block into each row of memory spaces of each memory page of the memory 360.

Take the memory space configuration in FIG. 6 as example, the memory controller 350 can select a rectangular data block having the bytes B_{0,0}, B_{0,7}, B_{63,0}, and B_{63,7} located at four corners as a first sub-block and individually store the 64 rows data of the first sub-block into 64 rows of memory spaces of a p^{th} memory page of the memory 360; select a rectangular data block having the bytes B_{0,8}, B_{0,15}, B_{63,8}, and B_{63,15} located at four corners as a second sub-block and individually store the 64 rows data of the second sub-block into 64 rows of memory spaces of a (p+1)^{th} memory page of the memory 360; select a rectangular data block having the bytes B_{0,16}, B_{0,23}, B_{63,16}, and B_{63,23} located at four corners as a third sub-block and individually store the 64 rows data of the third sub-block into 64 rows of memory spaces of a (p+2)^{th} memory page of the memory 360, and so on.

Please note that, the access operation is corresponding to the 1^{st} direction in FIG. 2. As for accessing the data of each row (each row includes 156 bytes), the memory address will be increased by 64 bytes every time when accessing one byte of data and a page miss will happen every time when accessing 8 bytes. Moreover, due to 156 being not divisible by 8 with no remainder, the 5^{th}, 6^{th}, 7^{th}, and 8^{th} columns of memory spaces of the (p+19)^{th}, (p+39)^{th}, (p+59)^{th}, . . . , (p+159)^{th} memory pages are not occupied by the data of the error correction code block 200. Similarly, due to 496 being not divisible by 64 with no remainder, the 49^{th}, 50^{th}, 51^{st}, . . . , and 64^{th} rows of memory spaces of the (p+140)^{th}, (p+141)^{th}, (p+142)^{th}, . . . , (p+159)^{th} memory pages are not occupied by the data of the error correction code block 200. Thus, the memory controller 350 can utilize the non-occupied memory spaces to store other data.

Step 730: The memory controller 350 reads data from the error correction code block 200 and transmits the error correction code block 200 to the decoding module 320 for performing parity decoding. At this time, the access operation is along the 2^{nd} direction in FIG. 2, which is the column direction of the memory space matrix that each memory page corresponds to in FIG. 6. The data of each column is read out and transmitted to the decoding module 320 for performing decoding. To explain more explicitly, the memory controller 350 can individually read the data from the 1^{st} column, the 2^{nd} column, . . . , and the 8^{th} column of the p^{th}, (p+20)^{th}, (p+40)^{th}, . . . , and (p+140)^{th} memory pages and transmit them to the decoding module 320 for performing the parity decoding. Due to each column including 64 data, 64 bytes can be accessed at one time without a page miss in this step. In other words, a page miss will happen every time after accessing 64 bytes.

Step 740: The controller 350 receives the parity decoded block from the decoding module 320 and stores the parity decoded block into the memory 360. The access operation is along the 2^{nd} direction in FIG. 2, wherein the data stored into the memory 360 only includes 432 rows×156 columns (these data have already been parity decoded and may be a little different from the data inside the rectangular data block having the bytes B_{0,0}, B_{0,155}, B_{431,0}, and B_{431,155} located at four corners in FIG. 2). At this time, the memory controller 350 will divide the received parity decoded block into several sub-blocks and store each column of data of each sub-block into each column of memory spaces of each memory page in the memory 360.

For example, the memory controller 350 can select a rectangular data block having the bytes B_{0,0}, B_{0,7}, B_{63,0}, and B_{63,7} located at four corners as a first sub-block and individually store the 8 columns data of the first sub-block into 8 columns of memory spaces of a q^{th} memory page of the memory 360 (the value of q in this step can equal the value of p in step 720); select a rectangular data block having the bytes B_{0,8}, B_{0,15}, B_{63,8}, and B_{63,15} located at four corners as a second sub-block and individually store the 8 columns data of the second sub-block into 8 columns of memory spaces of a (q+1)^{th} memory page of the memory 360; select a rectangular data block having the bytes B_{0,16}, B_{0,23}, B_{63,16}, and B_{63,23} located at four corners as a third sub-block and individually store the 8 columns data of the third sub-block into 8 columns memory spaces of a (q+2)^{th} memory page of the memory 360, and so on.

Please note that, the access operation is corresponding to the 2^{nd} direction in FIG. 2. As for accessing the data of each column (each column includes 64 bytes), 64 bytes can be accessed at one time without a page miss in this step. In otherwords, a page miss will happen every time after accessing 64 bytes. Moreover, due to 156 being not divisible by 8 with no remainder, the 5^{th}, 6^{th}, 7^{th}, and 8^{th} columns of memory spaces of the (q+19)^{th}, (q+39)^{th}, (q+59)^{th}, . . . , (q+139)^{th} memory pages are not occupied by the parity decoded block. Similarly, due to 432 being not divisible by 64 with no remainder, the 49^{th}, 50^{th}, 51^{st}, . . . , and 64^{th} rows of memory spaces of the (q+120)^{th}, (q+121)^{th}, (q+122)^{th}, . . . , and (q+139)^{th} memory pages are not occupied by the parity decoded block. Thus, the memory controller 350 can utilize the non-occupied memory spaces to store other data.

Step 750: The memory controller 350 reads the parity decoded block from the memory 360 and transmits the parity decoded block to the host interface 330 (the host interface 330 can transmit the received parity decoded block to a host device). At this time, the access operation is along the 2^{nd} direction in FIG. 2, which is the column direction of the memory space matrix that each memory page corresponds to in FIG. 6. The data of each column is read out and transmitted to the host interface 330. To explain more explicitly, the memory controller 350 can individually read the data from the 1^{st} column, the 2^{nd} column, . . . , and the 8^{th} column of the q^{th}, (q+20)^{th}, (q+40)^{th}, . . . , and (q+120)^{th} memory pages of the memory 360 and transmit them to the host interface 330. Due to each column including 64 data, 64 bytes can be accessed at one time without a page miss in the step. In other words, a page miss will happen every time after accessing 64 bytes.

The memory spaces of each memory page of the memory 360 are utilized through the abovementioned matrix corresponding manner. When accessing the BD disc, both the access efficiencies of the 1^{st} direction and the 2^{nd} direction in FIG. 2 can be considered. When accessing along the 2^{nd} direction, 64 bytes can be accessed at one time without a page miss due to the memory addresses being continuous. When accessing along the 1^{st} direction, 8 bytes can be accessed at one time without a page miss due to the memory addresses being increased by 64 bytes every time. Hence, the access efficiency along the 1^{st} direction is 4-8 times that of the prior art. Under this configuration, FIFO buffers for the accesses of the 2^{nd} direction only require 64 bytes and FIFO buffers for the accesses of the 1^{st} direction only need 8 bytes, which can elaborate this kind of matrix corresponding manner to a maximum efficiency.

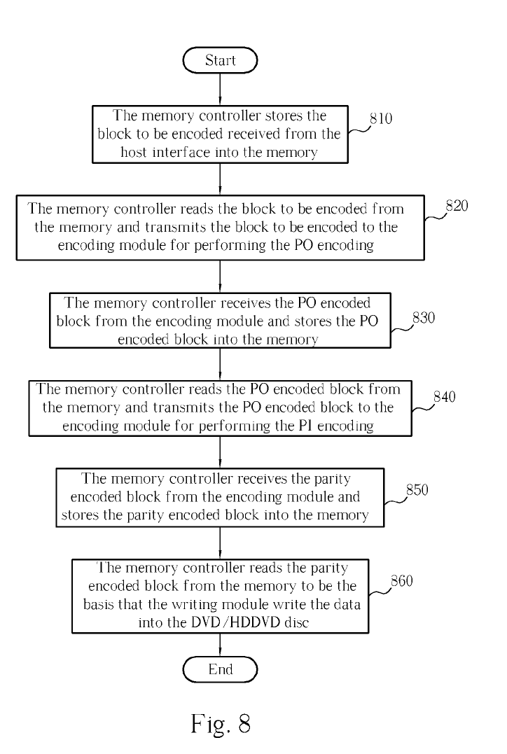

Please refer to FIG. 8. FIG. 8 is a flow diagram illustrating a method for the optical disc drive 300 in FIG. 3 to write data into a DVD disc or a HDDVD disc. The flow diagram includes the following steps:

Step 810: The memory controller 350 stores the block to be decoded received from the host interface 330 into the memory 360. Please refer back to FIG. 1, in order to consider both the access efficiencies in the 1^{st} direction and in the 2^{nd} direction, the memory controller 350 will divide the block to be decoded into a plurality of sub-blocks with matrix characteristics and store the data of each row of each sub-block into the memory spaces of each row of each memory page in the memory 360. Please note that, each of the blocks to be decoded is called as a block to be processed, and each sub-block is called as a sub-block to be decoded or a sub-block to be processed.

When cooperating with the error correction code block 100 in FIG. 1 (take out the parity inner codes PI and the parity outer codes PO) and taking the memory space configuration in FIG. 4 as example, the memory controller 350 can select a rectangular data block having the bytes B_{0,0}, B_{0,63}, B_{7,0}, and B_{7,63} located at four corners as a first sub-block and individually store the eight rows data of the first sub-block into eight rows of memory spaces of a j^{th} memory page; select a rectangular data block having the bytes B_{0,64}, B_{0,127}, B_{7,64}, and B_{7,127} located at four corners as a second sub-block and individually store the eight rows data of the second sub-block into eight rows of memory spaces of a (j+1)^{th} memory page; select a rectangular data block having the bytes B_{0,128}, B_{0,171}, B_{7,128}, and B_{7,171} located at four corners as a third sub-block (because the parity inner codes PI have not been decoded yet) and individually store the eight rows data of the third sub-block into eight rows of memory spaces of a (j+2)^{th} memory page, and so on.

Please note that, the access operation is corresponding to the 1^{st} direction in FIG. 1. As for accessing the data of each row (each row includes 172 bytes), a page miss will happen every time when accessing 64 bytes. Moreover, due to 172 being not divisible by 64 with no remainder, the 45^{th}, 46^{th}, . . . , 64^{th} columns of memory spaces of the (j+2)^{th}, (j+5)^{th}, (j+8)^{th}, . . . , (j+71)^{th} memory pages are not occupied by the data of the block to be decoded. Thus, the memory controller 350 can utilize the non-occupied memory spaces to store other data.

Step 820: The memory controller 350 reads the block to be encoded from the memory 360 and transmits the block to be encoded to the encoding module 320 for performing the PO encoding. At this time, the access operation is along the 2^{nd} direction in FIG. 1, which is the column direction of the memory space matrix that each memory page corresponds to in FIG. 4. The data of each column is read out and transmitted to the encoding module 320 for performing encoding. To explain more explicitly, the memory controller 350 can individually read the data from the 1^{st} column, the 2^{nd} column, . . . , and the 64^{th} column of the j^{th}, (j+3)^{th}, (j+6)^{th}, . . . , and (j+69)^{th} memory pages and transmit them to the encoding module 320 for performing the PO encoding. Due to each column including eight data, 8 bytes can be accessed at one time without a page miss in the step.

Step 830: The memory controller 350 receives the PO encoded block (that is the data block has had the PO encoding performed but has not yet had the PI encoding performed) from the encoding module 320 and stores the PO encoded block into the memory 360. The access operation is along the 2^{nd} direction in FIG. 1, wherein the data stored into the memory 360 only includes 208 rows×172 columns (exclude PI parity). At this time, the memory controller 350 will divide the received PO encoded block into several sub-blocks and store each column of data of each sub-block into each column of memory spaces of each memory page in the memory 360.

For example, the memory controller 350 can select a rectangular data block having the bytes B_{0,0}, B_{0,63}, B_{7,0}, and B_{7,63} located at four corners as a first sub-block and individually store the 64 columns data of the first sub-block into 64 columns of memory spaces of a k^{th} memory page (the value of k in this step can equal the value of j in step 820); select a rectangular data block having the bytes B_{0,64}, B_{0,127}, B_{7,64}, and B_{7,127} located at four corners as a second sub-block and individually store the 64 columns data of the second sub-block into 64 columns of memory spaces of a (k+1)^{th} memory page; select a rectangular data block having the bytes B_{0,128}, B_{0,171}, B_{7,128}, and B_{7,171} located at four corners as a third sub-block and individually store the 64 columns data of the third sub-block into 64 columns of memory spaces of a (k+2)^{th} memory page, and so on.

Please note that, the access operation is corresponding to the 2^{nd} direction in FIG. 1. As for accessing the data of each column (each column includes 8 bytes), 8 bytes can be accessed at one time without a page miss in the step. In other words, a page miss will happen every time after accessing 8 bytes. Moreover, due to 172 being not divisible by 64 with no remainder, the 45^{th}, 46^{th}, . . . , 64^{th} columns of memory spaces of the (k+2)^{th}, (k+5)^{th}, (k+8)^{th}, . . . , (k+77)^{th} memory pages are not occupied by the parity decoded block. Thus, the memory controller 350 can utilize the non-occupied memory spaces to store other data.

Step 840: The memory controller 350 read the PO encoded block from the memory 360 and transmits the PO encoded block to the encoding module 320 for performing the PI encoding. At this time, the access operation is along the 1^{st} direction in FIG. 1, which is the row direction of the memory space matrix that each memory page corresponds to in FIG. 4. The data of each row is read out and transmitted to the encoding module 320 for performing encoding. To explain more explicitly, the memory controller 350 can individually read the data from the 1^{st} row, the 2^{nd} row, . . . , and the 8^{th} row of the j^{th}, (j+1)^{th}, and (j+2)^{th} memory pages and transmit them to the encoding module 320 for performing the PI encoding. Due to each row including 64 bytes data, 64 bytes can be accessed at one time without a page miss in the step.

Step 850: The memory controller 350 receives the parity encoded block (that is the data block has already had both the PO encoding and the PI encoding performed) from the encoding module 320 and stores the parity encoded block into the memory 360. The access operation is along the 1^{st} direction in FIG. 1, wherein the data stored into the memory 360 only includes 208 rows×182 columns. At this time, the memory controller 350 will divide the received parity encoded block into several sub-blocks and store each row of data of each sub-block into each row of memory spaces of each memory page in the memory 360.

For example, the memory controller 350 can select a rectangular data block having the bytes B_{0,0}, B_{0,63}, B_{7,0} and B_{7,63} located at four corners as a first sub-block and individually store the 8 rows data of the first sub-block into 8 rows of memory spaces of a k^{th} memory page (the value of k in this step can equal the value of j in step 840); select a rectangular data block having the bytes B_{0,64}, B_{0,127}, B_{7,64}, and B_{7,127} located at four corners as a second sub-block and individually store the 8 rows data of the second sub-block into 8 rows of memory spaces of a (k+1)^{th} memory page; select a rectangular data block having the bytes B_{0,128}, B_{0,181}, B_{7,128}, and B_{7,181} located at four corners as a third sub-block and individually store the 8 rows data of the third sub-block into 8 rows of memory spaces of a (k+2)^{th} memory page, and so on.

Please note that, the access operation is corresponding to the 1^{st} direction in FIG. 1. As for accessing the data of each row (each row includes 64 bytes), 64 bytes can be accessed at one time without a page miss in the step. In other words, a page miss will happen every time after accessing 64 bytes. Moreover, due to 182 being not divisible by 64 with no remainder, the 54^{th}, 55^{th}, 56^{th}, . . . , 63^{rd} columns of memory spaces of the (k+2)^{th}, (k+5)^{th}, (k+8)^{th}, . . . , (k+77)^{th} memory pages are not occupied by the parity encoded block. Thus, the memory controller 350 can utilize the non-occupied memory spaces to store other data. At this time, the parity encoded block having the bytes B_{0,128}, B_{0,181}, B_{207,0}, and B_{207,181} located at four corners is the error correction code block 100.

Step 860: The memory controller 350 reads the parity encoded block from the memory 360 and transmits the parity encoded block to the writing module 310 (the writing module 310 can write the received data into the DVD disc or the HDDVD disc). At this time, the access operation is along the 1^{st} direction in FIG. 1, which is the row direction of the memory space matrix that each memory page corresponds to in FIG. 4. The data of each row is read out and transmitted to the writing module 310. To explain more explicitly, the memory controller 350 can individually read the data from the 1^{st} row, the 2^{nd} row, . . . , and the 8^{th} row of the k^{th}, (k+1)^{th}, and (k+2)^{th} memory pages and transmit them to the writing module 310. Due to each row including 64 data, 64 bytes can be accessed at one time without a page miss in the step. In other words, a page miss will happen every time after accessing 64 bytes.

The memory spaces of each memory page of the memory 360 are utilized through the abovementioned matrix corresponding manner. When accessing the DVD disc (or the HDDVD disc), both the access efficiencies of the 1^{st} direction and the 2^{nd} direction in FIG. 1 can be considered. When accessing along the 1^{st} direction, 64 bytes can be accessed at one time without a page miss due to the memory addresses being continuous. In other words, a page miss will happen every time after accessing 64 bytes. When accessing along the 2^{nd} direction, 8 bytes can be accessed at one time without a page miss due to the memory addresses being increased by 64 bytes every time. Hence, the access efficiency along the 2^{nd} direction is 2.6-4 times that of the prior art. Under this configuration, FIFO buffers for the accesses of the 1^{st} direction only require 64 bytes and FIFO buffers for the accesses of the 2^{nd} direction only need 8 bytes, which can elaborate this kind of matrix corresponding manner to a maximum efficiency.

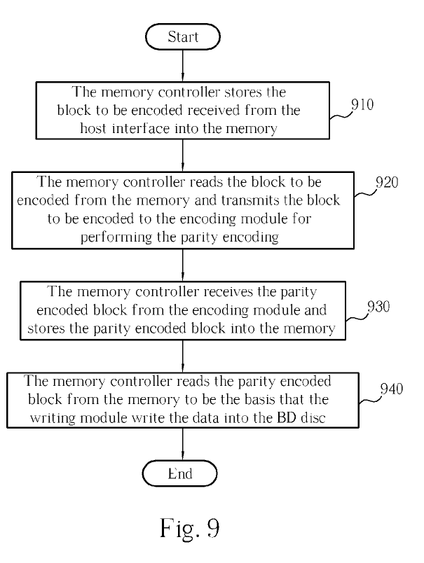

Please refer to FIG. 9. FIG. 9 is a flow diagram illustrating a method for the optical disc drive 300 in FIG. 3 to write data into a BD disc. The flow diagram includes the following steps:

Step 910: The memory controller 350 stores the block to be encoded received from the host interface 330 into the memory 360. Please refer back to FIG. 2, in order to consider both the access efficiencies in the 1^{st} direction and in the 2^{nd} direction, the memory controller 350 will divide the block to be encoded into a plurality of sub-blocks with matrix and store the data of each column of each sub-block into the memory spaces of each column of each memory page in the memory 360. Please note that, each of the blocks to be encoded is called as a block to be processed, and each sub-block is called as a sub-block to be encoded or a sub-block to be processed.

When cooperating with the error correction code block 200 in FIG. 2 and taking the memory space configuration in FIG. 6 as example, the memory controller 350 can select a rectangular data block having the bytes B_{0,0}, B_{0,7}, B_{63,0}, and B_{63,7} located at four corners as a first sub-block and individually store the eight columns data of the first sub-block into eight columns of memory spaces of a j^{th} memory page of the memory 360; select a rectangular data block having the bytes B_{0,8}, B_{0,15}, B_{63,8}, and B_{63,15} located at four corners as a second sub-block and individually store the eight columns data of the second sub-block into 8 columns of memory spaces of a (j+1)^{th} memory page of the memory 360; select a rectangular data block having the bytes B_{0,16}, B_{0,23}, B_{63,16}, and B_{63,23} located at four corners as a third sub-block and individually store the 8 columns data of the third sub-block into 8 columns of memory spaces of a (j+2)^{th} memory page, and so on.

Please note that, the access operation is corresponding to the 2^{nd} direction in FIG. 2. As for accessing the data of each column (each column includes 432 bytes), 64 bytes can be accessed at one time without a page miss in the step. In other words, a page miss will happen every time after accessing 64 bytes. Moreover, due to 156 being not divisible by 8 with no remainder, the 5^{th}, 6^{th}, 7^{th}, and 8^{th} columns of memory spaces of the (j+19)^{th}, (j+39)^{th}, (j+59)^{th}, . . . , (j+139)^{th} memory pages are not occupied by the data of the block to be decoded. Thus, the memory controller 350 can utilize the non-occupied memory spaces to store other data. Similarly, due to 432 being not divisible by 64 with no remainder, the 49^{th}, 50^{th}, 51^{st}, . . . , and 64^{th} rows of memory spaces of the (j+120)^{th}, (j+121)^{th}, (j+122)^{th}, . . . , (j+139)^{th} memory pages are not occupied by the data of the block to be encoded. Thus, the memory controller 350 can utilize the non-occupied memory spaces to store other data.

Step 920: The memory controller 350 reads the block to be encoded from the memory 360 and transmits the block to be encoded to the encoding module 320 for performing the parity encoding. At this time, the access operation is along the 2^{nd} direction in FIG. 2, which is the column direction of the memory space matrix that each memory page corresponds to in FIG. 6. The data of each column is read out and transmitted to the encoding module 320 for performing encoding. To explain more explicitly, the memory controller 350 can individually read the data from the 1^{st} column, the 2^{nd} column, . . . , and the 8^{th} column of the j^{th}, (j+20)^{th}, (j+40)^{th}, . . . , and (j+120)^{th} memory pages of the memory 360 and transmit them to the encoding module 320 for performing the parity encoding. Due to each column including 64 data, 64 bytes can be accessed at one time without a page miss in the step. In other words, a page miss will happen every time after accessing 64 bytes.

Step 930: The memory controller 350 receives the parity encoded block (that is the data block has had the parity encoding performed) from the encoding module 320 and stores the parity encoded block into the memory 360. The access operation is along the 2^{nd} direction in FIG. 2, wherein the data stored into the memory 360 only includes 496 rows×156 columns. At this time, the memory controller 350 will divide the received parity encoded block into several sub-blocks and store each column of data of each sub-block into each column of memory spaces of each memory page in the memory 360.

For example, the memory controller 350 can select a rectangular data block having the bytes B_{0,0}, B_{0,7}, B_{63,0}, and B_{63,7} located at four corners as a first sub-block and individually store the 8 columns data of the first sub-block into 8 columns of memory spaces of a k^{th} memory page of the memory 360 (the value of k in this step can equal the value of j in step 920); select a rectangular data block having the bytes B_{0,8}, B_{0,15}, B_{63,8}, and B_{63,15} located at four corners as a second sub-block and individually store the 8 columns data of the second sub-block into 8 columns of memory spaces of a (k+1)^{th} memory page of the memory 360; select a rectangular data block having the bytes B_{0,16}, B_{0,23}, B_{63,16}, and B_{63,23} located at four corners as a third sub-block and individually store the 8 columns data of the third sub-block into 8 columns of memory spaces of a (k+2)^{th} memory page of the memory 360, and so on.

Please note that, the access operation is corresponding to the 2^{nd} direction in FIG. 2. As for accessing the data of each column (each column includes 64 bytes), 64 bytes can be accessed at one time with out a page miss in the step. In other words, a page miss will happen every time after accessing 64 bytes. Moreover, due to 496 being not divisible by 64 with no remainder, the 49^{th}, 50^{th}, 51^{st}, . . . , and 64^{th} rows of memory spaces of the (k+140)^{th}, (k+141)^{th}, (k+142)^{th}, . . . , (k+159)^{th} memory pages are not occupied by the parity encoded block. Thus, the memory controller 350 can utilize the non-occupied memory spaces to store other data.

Step 940: The memory controller 350 reads the parity encoded block from the memory 360 and transmits the parity encoded block to the writing module 310 (the writing module 310 can write the received data into the BD disc). At this time, the access operation is along the 1^{st} direction in FIG. 2, which is the row direction of the memory space matrix that each memory page corresponds to in FIG. 6. The data of each row is read out and transmitted to the writing module 310. To explain more explicitly, the memory controller 350 can individually read the data from the 1^{st} row, the 2^{nd} row, . . . , and the 64^{th} row of the k^{th}, (k+1)^{th}, (k+2)^{th}, . . . , and (k+19)^{th} memory pages and transmit them to the writing module 310. Due to each row including 8 bytes data, 8 bytes can be accessed at one time without a page miss in the step.

The memory spaces of each memory page of the memory 360 are utilized through the abovementioned matrix corresponding manner. When accessing the BD disc, both the access efficiencies of the 1^{st} direction and the 2^{nd} direction in FIG. 1 can be considered. When accessing along the 2^{nd} direction, 64 bytes can be accessed at one time without a page miss due to the memory addresses being continuous. In other words, a page miss will happen every time after accessing 64 bytes. When accessing along the 1^{st} direction, 8 bytes can be accessed at one time without a page miss due to the memory addresses being increased by 64 bytes every time. Hence, the access efficiency along the 1^{st} direction is 4-8 times that of the prior art. Under this configuration, FIFO buffers for the accesses of the 2^{nd} direction only require 64 bytes and FIFO buffers for the accesses of the 1^{st} direction only need 8 bytes, which can elaborate this kind of matrix corresponding manner to a maximum efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for buffering data when reading an optical disc comprising:
providing a memory page with a plurality of memory spaces corresponding to a memory space matrix with M rows×N columns; and
reading data stored in the optical disc to generate a block to be decoded, selecting M rows×N columns of data from the block as a sub-block to be decoded, and storing the M rows of data of the sub-block into the M rows of memory spaces of the memory space matrix respectively.

2. The method of claim 1, wherein the optical disc is a digital versatile disc (DVD) or a high definition digital versatile disc (HD-DVD), and the step of reading data stored in the optical disc further comprises:
reading data stored in the optical disc to obtain an error correction code block (ECC block) and performing a PI decoding on the error correction code block to obtain a PI decoded block, wherein the PI decoded block is the block to be decoded.

3. The method of claim 2 further comprising:
reading the N columns of PI decoded data stored in the N columns of memory spaces of the memory space matrix, performing a PO decoding on the N columns of the PI decoded data to obtain N columns of parity decoded data, and storing the N columns of parity decoded data into the N columns of memory spaces of the memory space matrix respectively.

4. The method of claim 3 further comprising:
reading the M rows of parity decoded data stored in the M rows of memory spaces of the memory space matrix and transmitting the M rows of parity decoded data to a host interface.

5. The method of claim 1, wherein the optical disc is a blue-ray disc (BD), and the block to be decoded is an error correction code block obtained from the method of reading data stored in the optical disc.

6. The method of claim 5 further comprising:
reading the N columns of the data to be decoded stored in the N columns of memory spaces of the memory space matrix, performing a parity decoding on the N columns of the data to be decoded to obtain N columns of parity decoded data, and storing the N columns of parity decoded data into the N columns of memory spaces of the memory space matrix respectively.

7. The method of claim 6 further comprising:
reading the N columns of parity decoded data stored in the N columns of memory spaces of the memory space matrix, and transmitting the N columns of parity decoded data to a host interface.

8. A buffering module for an optical disc drive, the optical disc drive comprising a reading module, a decoding module, and a host interface, the buffering module comprising:
a memory comprising a memory page with a plurality of memory spaces corresponding to a memory space matrix with M rows×N columns; and
a memory controller coupled to the memory, the reading module, the decoding module, and the host interface, the memory controller used for receiving a block to be decoded which is obtained through reading an optical disc by the reading module, selecting M rows×N columns of data from the block to be decoded as a sub-block to be decoded, and storing the M rows of data of the sub-block to be decoded into the M rows of memory spaces of the memory space matrix respectively.

9. The buffering module of claim 8, wherein:
the optical disc is a digital versatile disc (DVD) or a high definition digital versatile disc (HD-DVD);
the memory controller is further used for reading the N columns of PI decoded data stored in the N columns of memory spaces of the memory space matrix to be transmitted to the decoding module, and receiving N columns of parity decoded data from the decoding module to store the parity decoded data into the N columns of memory spaces of the memory space matrix; and
the decoding module is further used for performing a PO decoding on the N columns of the PI decoded data to obtain the N columns of parity decoded data.

10. The buffering module of claim 9, wherein the memory controller is further used for reading the M rows of the parity decoded data stored in the M rows of memory spaces of the memory space matrix to be transmitted to the host interface.

11. The buffering module of claim 8, wherein the optical disc is a blue-ray disc (BD), and the memory controller is further used for reading the N columns of data to be decoded stored in the N columns of memory spaces of the memory space matrix to be transmitted to the decoding module, and receiving the N columns of the parity decoded data to be stored into the N columns of memory spaces of the memory space matrix.

12. The buffering module of claim 11, wherein the memory controller is further used for reading the N columns of the parity decoded data stored in the N columns of the memory spaces of the memory space matrix to be transmitted to the host interface.

13. A method for buffering data when accessing an optical disc comprising:
providing a memory page with a plurality of memory spaces corresponding to a memory space matrix with M rows×N columns; and
receiving a block to be processed, selecting M rows×N columns of data from the block to be processed as a sub-block to be processed, and storing the M rows of data of the sub-block to be processed into the M rows of memory spaces of the memory space matrix respectively.

14. The method of claim 13, wherein the optical disc is a digital versatile disc (DVD) or a high definition digital versatile disc (HD-DVD), and each two adjacent memory spaces of each row of memory space in the memory space matrix correspond to two continuous memory addresses, and each two adjacent memory spaces of each column of memory space in the memory space matrix correspond to two memory addresses with a fixed address difference.

15. A method for buffering data when accessing an optical disc comprising:
providing a memory page with a plurality of memory spaces corresponding to a memory space matrix with M rows×N columns; and
receiving a block to be processed, selecting M rows×N columns of data from the block to be processed as a sub-block to be processed, and storing the N columns of data of the sub-block to be processed into the N columns of memory spaces of the memory space matrix respectively.

16. The method of claim 15, wherein the optical disc is a digital versatile disc (DVD) or a high definition digital versatile disc (HD-DVD), and each two adjacent memory spaces of each column of memory space in the memory space matrix correspond to two continuous memory addresses, and each two adjacent memory spaces of each row of memory space in the memory space matrix correspond to two memory addresses with a fixed address difference.

17. A buffering module for an optical disc drive, the optical disc drive comprising a reading module and a decoding module, the buffering module comprising:
a memory comprising a memory page with a plurality of memory spaces corresponding to a memory space matrix with M rows×N columns; and
a memory controller coupled to the memory, the reading module, and the decoding module, the memory controller used for receiving a block to be processed, selecting M rows×N columns of data from the block to be processed as a sub-block to be processed, and storing the M rows of data of the sub-block to be processed into the M rows of memory spaces of the memory space matrix respectively.

18. The buffering module of claim 17, wherein the optical disc is a digital versatile disc (DVD) or a high definition digital versatile disc (HD-DVD), and each two adjacent memory spaces of each row of memory space in the memory space matrix correspond to two continuous memory addresses, and each two adjacent memory spaces of each column of memory space in the memory space matrix correspond to two memory addresses with a fixed address difference.

19. A buffering module for an optical disc drive, the optical disc drive comprising a reading module and a decoding module, the buffering module comprising:
a memory comprising a memory page with a plurality of memory spaces corresponding to a memory space matrix with M rows×N columns; and
a memory controller coupled to the memory, the reading module, and the decoding module, the memory controller used for receiving a block to be processed, selecting M rows×N columns of data from the block to be processed as a sub-block to be processed, and storing the N columns of data of the sub-block to be processed into the N columns of memory spaces of the memory space matrix respectively.

20. The buffering module of claim 19, wherein the optical disc is a digital versatile disc (DVD) or a high definition digital versatile disc (HD-DVD), and each two adjacent memory spaces of each column of memory space in the memory space matrix correspond to two continuous memory addresses, and each two adjacent memory spaces of each row of memory space in the memory space matrix correspond to two memory addresses with a fixed address difference.
